(19) United States
(12) Patent Application Publication
(10) Pub. No.: US 2024/0356127 A1
(43) Pub. Date: Oct. 24, 2024

(54) ADHESIVE-SEALANT, BATTERY CELL, BATTERY, AND ELECTRICAL DEVICE

(71) Applicant: Ningde Amperex Technology Limited, Ningde City (CN)

(72) Inventors: Hengtao Xia, Ningde City (CN); Jian Wu, Ningde City (CN)

(73) Assignee: Ningde Amperex Technology Limited, Ningde City (CN)

(21) Appl. No.: 18/757,802

(22) Filed: Jun. 28, 2024

Related U.S. Application Data
(63) Continuation of application No. PCT/CN2021/142430, filed on Dec. 29, 2021.

(51) Int. Cl. H01M 50/198; H01M 50/105; H01M 50/178; H01M 50/186; H01M 50/193; H01M 50/197

(52) U.S. Cl. CPC H01M 50/198; H01M 50/105; H01M 50/178; H01M 50/186; H01M 50/193; H01M 50/197

(57) ABSTRACT

An adhesive-sealant includes a first adhesive layer and a second adhesive layer arranged continuously along a first direction. The first direction is perpendicular to a thickness direction of the first adhesive layer. A melting point of the first adhesive layer is lower than a melting point of the second adhesive layer. A difference in the melting point between the first adhesive layer and the second adhesive layer is 15° C. to 55° C. This application further provides a battery cell containing the adhesive-sealant, a battery, and an electrical device. The adhesive-sealant is configured to implement connection between a tab and a packaging bag to improve performance of sealing and insulation at a junction between the tab and the packaging bag.

### CROSS-REFERENCE TO RELATED APPLICATION

This application is a continuation of International Patent Application No. PCT/CN2021/142430, filed on Dec. 29, 2021, the disclosure of which is hereby incorporated by reference in its entirety.

### TECHNICAL FIELD

This application relates to the technical field of batteries, and in particular, to an adhesive-sealant, a battery cell, a battery, and an electrical device.

### BACKGROUND

To improve the hermeticity of a battery cell, tabs are typically connected to a packaging bag by an adhesive-sealant. Conventional adhesive-sealants currently available on the market are typically made of a single material and melt at a relatively high melting point. When the temperature of the battery cell rises abnormally, the adhesive-sealant is not easily meltable, thereby resulting in swelling and gassing in the packaging bag and impairing the safety of the battery cell.

### SUMMARY

In view of the above situation, it is necessary to provide an adhesive-sealant containing constituents of different melting points, and a battery cell of high safety performance.

An embodiment of this application provides an adhesive-sealant. The adhesive-sealant includes a first adhesive layer and a second adhesive layer arranged continuously along a first direction. The first direction is perpendicular to a thickness direction of the first adhesive layer. A melting point of the first adhesive layer is lower than a melting point of the second adhesive layer. A difference in the melting point between the first adhesive layer and the second adhesive layer is 15° C. to 55° C.

The adhesive-sealant is configured to implement connection between a tab and a packaging bag to improve performance of sealing and insulation at a junction between the tab and the packaging bag. When the adhesive-sealant is used in a battery cell and when the temperature of the battery cell rises abnormally, the temperature of the tab also rises accordingly. When the temperature of the battery cell reaches the melting point range of the first adhesive layer, the first adhesive layer will melt to reduce the sealing strength at the junction between the first adhesive layer and the packaging bag, thereby reducing the sealing strength between the adhesive-sealant and the packaging bag. This facilitates the gas generated by high temperature to burst the junction between the adhesive-sealant and the packaging bag, reduces the heat accumulation and deformation inside the battery cell, and improves the safety of the battery cell.

In some embodiments of this application, the melting point of the first adhesive layer ranges from 110° C. to 130° C. By setting the lower limit of the melting point of the first adhesive layer to 110° C., this application reduces the risk of melting the first adhesive layer when the temperature of the battery cell rises during normal operation. By setting the upper limit of the melting point of the first adhesive layer to 130° C., this application makes the first adhesive layer melt in the melting point range of 110° C. to 130° C., and reduces the safety hazards caused by an increase of the temperature of the battery cell beyond 130° C.

In some embodiments of this application, the first adhesive layer includes polypropylene and/or polyethylene. When the first adhesive layer includes the polypropylene and the polyethylene, a mass percent of the polypropylene in the first adhesive layer is 30% to 50%, and a mass percent of the polyethylene in the first adhesive layer is 50% to 70%, thereby controlling the melting point of the first adhesive layer to fall within the range of 110° C. to 130° C. and making the first adhesive layer both rigid and flexible.

In some embodiments of this application, the second adhesive layer includes fibers and polypropylene. A mass percent of the fibers in the second adhesive layer is 3% to 10%, and a mass percent of the polypropylene in the second adhesive layer is 90% to 97%. The fibers are configured to increase the structural strength of the second adhesive layer. Compared with the first adhesive layer, the melting point of polypropylene is higher than the melting point of a hybrid of polypropylene and polyethylene. The mass percent of polypropylene in the second adhesive layer is 90% or above, so that the melting point of the second adhesive layer is lower than the melting point of the first adhesive layer. In addition, the second adhesive layer is a composite layer of fibers and polypropylene, thereby reducing the problems of over-melting and adhesive overflow in the sealing region during heat sealing arising from poor sealing parallelism, excessive sealing pressure, or excessive sealing temperature, and in turn, reducing the problems of battery corrosion and leakage at the tabs caused by the contact between the tab and the aluminum layer of the packaging bag.

In some embodiments of this application, the adhesive-sealant includes two second adhesive layers. Along the first direction, the first adhesive layer is disposed between the two second adhesive layers to improve the stability of the second adhesive layers supporting the first adhesive layer, and increase the structural strength of the adhesive-sealant.

In some embodiments of this application, the adhesive-sealant further includes a plurality of through-holes created on the second adhesive layer. Each of the through-holes penetrates the second adhesive layer along a thickness direction of the second adhesive layer. The through-holes are configured to accommodate a colloid generated by melting the first adhesive layer, so as to limit the flow direction of the colloid and improve the efficiency of separating the first adhesive layer from the corresponding junction. In addition, the through-holes may be further configured to accommodate the colloid overflowing from the heated first adhesive layer during the heat sealing by the adhesive-sealant, so as to improve the sealing performance of the adhesive-sealant.

In some embodiments of this application, a distance from a center of the plurality of through-holes to a junction between the first adhesive layer and the second adhesive layer is less than or equal to 0.8 mm, so that the through-holes are located in a path to be traversed by the first adhesive layer after melting, thereby reducing the possibility of adhesive overflow during heat sealing.

An embodiment of this application further provides a battery cell. The battery cell includes an electrode assembly, a tab, and a packaging bag. The packaging bag includes an accommodation portion configured to accommodate the electrode assembly and a sealing portion connected to the accommodation portion. One end of the tab is connected to the electrode assembly, and another end of the tab extends out from the sealing portion. The battery cell further includes the adhesive-sealant disclosed in any one of the above embodiments. In a thickness direction of the adhesive-sealant, the adhesive-sealant is disposed between at least one surface of the tab and the sealing portion. The adhesive-sealant is at least partially disposed in the sealing portion.

In some embodiments of this application, a part of the first adhesive layer or a part of the second adhesive layer is disposed outside the sealing portion along the extension-out direction of the tab, so that the adhesive-sealant fully fills the clearance between the sealing portion and the tab, thereby improving the performance of sealing and insulation between the tab and the sealing portion.

In some embodiments of this application, the battery cell further includes a third adhesive layer partially disposed in the sealing portion. The adhesive-sealant is disposed on one surface of the tab. The third adhesive layer is disposed on another surface of the tab. The adhesive-sealant and the third adhesive layer are disposed opposite to each other, and each are configured to improve the performance of sealing and insulation between one of the two surfaces of the tab and the sealing portion.

In some embodiments of this application, the third adhesive layer may be polypropylene, or any one of the adhesive-sealants described above.

An embodiment of this application further provides a battery. The battery includes the battery cell disclosed in any one of the above embodiments and a protection circuit module connected to the battery cell.

An embodiment of this application further provides an electrical device. The electrical device includes the battery disclosed in any one of the above embodiments.

In the adhesive-sealant, the battery cell containing the adhesive-sealant, the battery, and the electrical device disclosed herein, the adhesive-sealant is configured to implement connection between a tab and a packaging bag to improve the performance of sealing and insulation at the junction between the tab and the packaging bag. When the adhesive-sealant is used in a battery cell and when the temperature of the battery cell rises abnormally, the temperature of the tab also rises accordingly. When the temperature of the battery cell reaches the melting point range of the first adhesive layer, the first adhesive layer will melt to reduce the sealing strength at the junction between the first adhesive layer and the packaging bag, thereby reducing the sealing strength between the adhesive-sealant and the packaging bag. This facilitates the gas generated by high temperature to burst the junction between the adhesive-sealant and the packaging bag, reduces the heat accumulation and deformation inside the battery cell, and improves the safety of the battery cell.

### BRIEF DESCRIPTION OF DRAWINGS

FIG. 1 is a first schematic top view of an adhesive-sealant according to an embodiment of this application;

FIG. 2 is a first schematic side view of an adhesive-sealant according to an embodiment of this application;

FIG. 3 is a first schematic extension diagram of a junction between a first adhesive layer and a second adhesive layer in an adhesive-sealant according to an embodiment of this application;

FIG. 4 is a second schematic extension diagram of a junction between a first adhesive layer and a second adhesive layer in an adhesive-sealant according to an embodiment of this application;

FIG. 5 is a schematic top view of a through-hole in an adhesive-sealant according to an embodiment of this application;

FIG. 6 is a cross-sectional schematic view of a through-hole in an adhesive-sealant according to an embodiment of this application;

FIG. 7 is a schematic structural diagram of a battery cell according to an embodiment of this application;

FIG. 8 is a second schematic top view of an adhesive-sealant according to an embodiment of this application;

FIG. 9 is a second schematic side view of an adhesive-sealant according to an embodiment of this application;

FIG. 10 is a third schematic top view of an adhesive-sealant according to an embodiment of this application;

FIG. 11 is a third schematic side view of an adhesive-sealant according to an embodiment of this application;

FIG. 12 is a fourth schematic top view of an adhesive-sealant according to an embodiment of this application;

FIG. 13 is a fourth schematic side view of an adhesive-sealant according to an embodiment of this application;

FIG. 14 is a schematic structural diagram of a battery according to an embodiment of this application; and

FIG. 15 is a schematic structural diagram of an electrical device according to an embodiment of this application.

### LIST OF REFERENCE NUMERALS

adhesive-sealant 100
battery cell 200
battery 300
electrical device 400
first adhesive layer 10
second adhesive layer 20
through-hole 30
electrode assembly 40
tab 50
packaging bag 60
accommodation portion 61
sealing portion 62
third adhesive layer 70
protection circuit module 91
device body 92
first direction A

This application is further described below with reference to the following specific embodiments and the foregoing drawings.

### DETAILED DESCRIPTION

The following describes the technical solutions in the embodiments of this application with reference to the drawings hereto. Evidently, the described embodiments are merely a part of but not all of the embodiments of this application.

It is hereby noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein includes any and all combinations of one or more relevant items enumerated. The terms “vertical”, “horizontal”, “left”, “right”, “top”, “bottom”, and similar expressions are used herein merely for ease of description but not for limiting this application.

Understandably, when two components are arranged parallel or perpendicular to each other along the same direction, a tolerable angle may exist between the two components. The angle between two components permits a tolerance of 0 to ±10%, and a measured value of the angle between the two components may be greater than, equal to, or less than the nominal value with a tolerance of 0 to ±10%.

An embodiment of this application provides an adhesive-sealant. The adhesive-sealant includes a first adhesive layer and a second adhesive layer arranged continuously along a first direction. The first direction is perpendicular to a thickness direction of the first adhesive layer. A melting point of the first adhesive layer is lower than a melting point of the second adhesive layer. A difference in the melting point between the first adhesive layer and the second adhesive layer is 15° C. to 55° C.

In the adhesive-sealant, the battery cell containing the adhesive-sealant, the battery, and the electrical device, the adhesive-sealant is configured to implement connection between a tab and a packaging bag to improve the performance of sealing and insulation at the junction between the tab and the packaging bag. When the adhesive-sealant is used in a battery cell and when the temperature of the battery cell rises abnormally, the temperature of the tab also rises accordingly. When the temperature of the battery cell reaches the melting point range of the first adhesive layer, the first adhesive layer will melt to reduce the sealing strength at the junction between the first adhesive layer and the packaging bag, thereby reducing the sealing strength between the adhesive-sealant and the packaging bag. This facilitates the gas generated by high temperature to burst the junction between the adhesive-sealant and the packaging bag, reduces the heat accumulation and deformation inside the battery cell, and improves the safety of the battery cell.

The following further describes the embodiments of this application with reference to drawings.

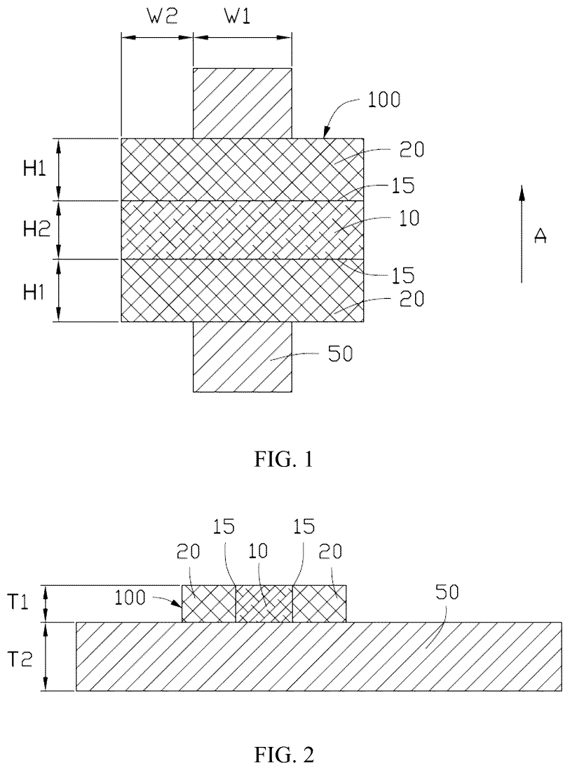

Referring to FIG. 1 and FIG. 2 together, an embodiment of this application provides an adhesive-sealant 100. The adhesive-sealant includes a first adhesive layer 10 and a second adhesive layer 20 arranged continuously along a first direction A. The first direction A is perpendicular to a thickness direction of the first adhesive layer 10. A melting point of the first adhesive layer 10 is lower than a melting point of the second adhesive layer 20. A difference in the melting point between the first adhesive layer 10 and the second adhesive layer 20 is 15° C. to 55° C.

The second adhesive layer 20 is configured to improve the structural strength of the adhesive-sealant 100, and provide support for the first adhesive layer 10 during heat sealing by the adhesive-sealant 100, thereby reducing the risk of adhesive overflow caused by a high deformation rate of the first adhesive layer 10 arising from pressure and high temperature. The melting point of the first adhesive layer 10 is lower than the melting point of the second adhesive layer 20. Therefore, the first adhesive layer 10 melts earlier than the second adhesive layer 20 in a high-temperature environment to reduce the sealing strength at the corresponding junction of the first adhesive layer 10.

In some embodiments, the difference in the melting point between the first adhesive layer 10 and the second adhesive layer 20 may be 15° C., 20° C., 25° C., 30° C., 35° C., 40° C., 45° C., 50° C., 55° C., or the like.

The adhesive-sealant 100 is configured to implement connection between a tab 50 and a packaging bag to improve performance of sealing and insulation at the junction between the tab 50 and the packaging bag. When the adhesive-sealant 100 is used in a battery cell and when the temperature of the battery cell rises abnormally, the temperature of the tab 50 also rises accordingly. When the temperature of the battery cell reaches the melting point range of the first adhesive layer 10, the first adhesive layer 10 will melt to reduce the sealing strength at the junction between the first adhesive layer 10 and the packaging bag, thereby reducing the sealing strength between the adhesive-sealant 100 and the packaging bag. This facilitates the gas generated by high temperature to burst the junction between the adhesive-sealant 100 and the packaging bag, reduces the heat accumulation and deformation inside the battery cell, and improves the safety of the battery cell.

In some embodiments, the melting point of the first adhesive layer 10 ranges from 110° C. to 130° C. By setting the lower limit of the melting point of the first adhesive layer 10 to 110° C., this application reduces the risk of melting the first adhesive layer 10 when the temperature of the battery cell rises during normal operation. By setting the upper limit of the melting point of the first adhesive layer 10 to 130° C., this application makes the first adhesive layer 10 melt in the melting point range of 110° C. to 130° C., and reduces the safety hazards caused by an increase of the temperature of the battery cell beyond 130° C.

In some embodiments, the melting point of the first adhesive layer 10 may be one of 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., or the like.

In some embodiments, the first adhesive layer 10 includes polypropylene and polyethylene.

Among the polypropylene and polyethylene materials, polypropylene is more heat-resistant than polyethylene. In other words, the melting point of polypropylene is higher than that of polyethylene. The polypropylene is more rigid than polyethylene, and polyethylene is more flexible than polyethylene. The mass percent of the polypropylene in the first adhesive layer 10 is 30% to 50%. The mass percent of the polyethylene in the first adhesive layer 10 is 50% to 70%, thereby controlling the melting point of the first adhesive layer 10 to fall within the range of 110° C. to 130° C. and making the first adhesive layer 10 both rigid and flexible.

In some embodiments, the mass percent of polypropylene in the first adhesive layer 10 may be one of 31%, 32%, 33%, 34%, 35%, 36%, 37%, 38%, 39%, 40%, 41%, 42%, 43%, 44%, 45%, 46%, 47%, 48%, 49%, 50%, or the like. Correspondingly, the mass percent of polyethylene in the first adhesive layer 10 may be one of 51%, 52%, 53%, 54%, 55%, 56%, 57%, 58%, 59%, 60%, 61%, 62%, 63%, 64%, 65%, 66%, 67%, 68%, 69%, 70%, or the like.

Understandably, in some embodiments, the first adhesive layer 10 includes polypropylene. The mass percent of polypropylene in the first adhesive layer 10 is 100%.

Understandably, in some embodiments, the first adhesive layer 10 includes polyethylene. The mass percent of polyethylene in the first adhesive layer 10 is 100%.

In some embodiments, the second adhesive layer 20 includes fibers and polypropylene. The mass percent of the fibers in the second adhesive layer 20 is 3% to 10%, and the mass percent of the polypropylene in the second adhesive layer 20 is 90% to 97%. The fibers are configured to increase the structural strength of the second adhesive layer 20. Compared with the first adhesive layer 10, the melting point of polypropylene is higher than the melting point of a hybrid of polypropylene and polyethylene. The mass percent of polypropylene in the second adhesive layer is 90% or above, so that the melting point of the second adhesive layer 20 is lower than the melting point of the first adhesive layer 10. The second adhesive layer 20 is a composite layer of fibers and polypropylene, thereby reducing the problems of over-melting and adhesive overflow in the sealing region during heat sealing arising from poor sealing parallelism, excessive sealing pressure, or excessive sealing temperature, and in turn, reducing the problems of battery corrosion and leakage at the tabs caused by the contact between the tab and the aluminum layer of the packaging bag.

In some embodiments, the fibers may be made of polymers of high mechanical strength, for example, polyphenylene sulfide (PPS), polyamide-imide (PAI), polytetrafluoroethylene (PTFE), or polyether ether ketone (PEEK).

In some embodiments, the mass percent of the fibers in the second adhesive layer 20 may be one of 3%, 4%, 5%, 6%, 7%, 8%, 9%, 10%, or the like. Correspondingly, the mass percent of polypropylene in the second adhesive layer 20 is one of 90%, 91%, 92%, 93%, 94%, 95%, 96%, 97%, or the like.

In some embodiments, the adhesive-sealant 100 includes two second adhesive layers 20. Along the first direction A, the first adhesive layer 10 is disposed between the two second adhesive layers 20. The first adhesive layer 10 is flanked by the two second adhesive layers 20 spaced apart to improve the stability of the second adhesive layers 20 supporting the first adhesive layer 10, and increase the structural strength of the adhesive-sealant 100. When the first adhesive layer 10 is melted, the gas generated by the high temperature bursts the junction between the first adhesive layer 10 and the packaging bag to form a clearance between the two second adhesive layers 20, thereby reducing the sealing strength at the junction between the adhesive-sealant 100 and the packaging bag, and facilitating the gas generated by the high temperature to rush out of the packaging bag.

In some embodiments, when viewed along the thickness direction of the adhesive-sealant 100, the junction 15 between the first adhesive layer 10 and the second adhesive layer 20 extends along a straight line.

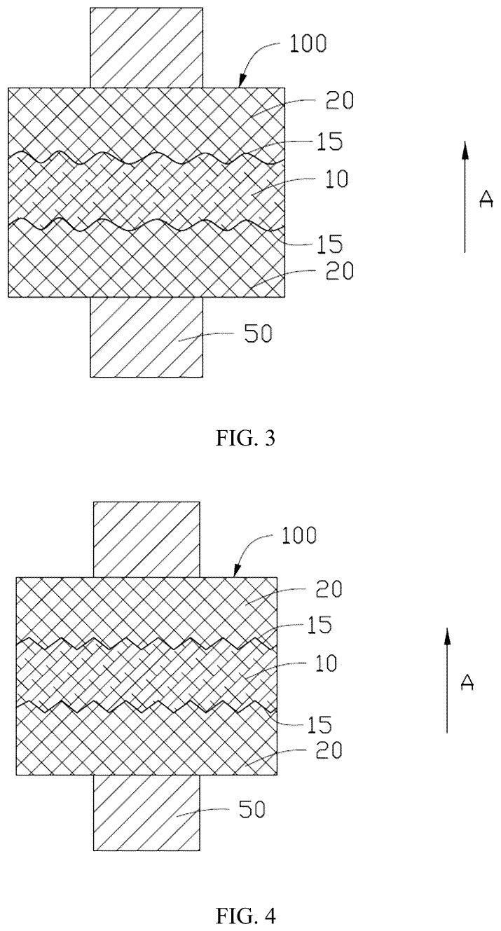

Referring to FIG. 3 together, understandably, in some embodiments, when viewed along the thickness direction of the adhesive-sealant 100, the junction between the first adhesive layer 10 and the second adhesive layer 20 extends along an arc line. Optionally, the arc line extends like a wavy line to increase the area of the junction 15 between the first adhesive layer 10 and the second adhesive layer 20, and in turn, improve the stability of the connection between the first adhesive layer 10 and the second adhesive layer 20.

Referring to FIG. 4 together, understandably, in some embodiments, when viewed along the thickness direction of the adhesive-sealant 100, the junction 15 between the first adhesive layer 10 and the second adhesive layer 20 extends along a zigzag line to increase the area of the junction 15 between the first adhesive layer 10 and the second adhesive layer 20, and in turn, improve the stability of the connection between the first adhesive layer 10 and the second adhesive layer 20.

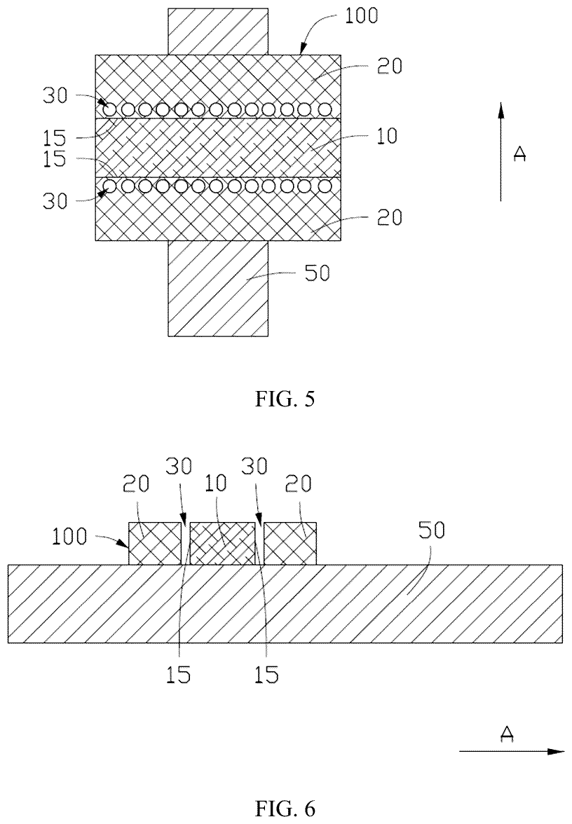

Referring to FIG. 5 and FIG. 6 together, in some embodiments, the adhesive-sealant 100 further includes a plurality of through-holes 30 created on the second adhesive layer 20. Each of the through-holes 30 penetrates the second adhesive layer 20 along the thickness direction of the second adhesive layer 20. The through-holes 30 are configured to accommodate a colloid generated by melting the first adhesive layer 10, so as to limit the flow direction of the colloid and improve the efficiency of separating the first adhesive layer 10 from the corresponding junction. In addition, the through-holes 30 may be further configured to accommodate the colloid overflowing from the heated first adhesive layer 10 during the heat sealing by the adhesive-sealant 100, so as to improve the sealing performance of the adhesive-sealant 100.

In some embodiments, a distance from a center of the plurality of through-holes 30 to the junction 15 between the first adhesive layer 10 and the second adhesive layer 20 is less than or equal to 0.8 mm, so that the through-holes 30 are located in a path to be traversed by the first adhesive layer 10 after melting.

In some embodiments, the distance from the center of the plurality of through-holes 30 to the junction 15 between the first adhesive layer 10 and the second adhesive layer 20 is one of 0.1 mm, 0.2 mm, 0.3 mm, 0.4 mm, 0.5 mm, 0.6 mm, 0.7 mm, 0.8 mm, or the like.

In some embodiments, the plurality of through-holes 30 are arranged at intervals along an extension direction of the junction 15 between the first adhesive layer 10 and the second adhesive layer 20.

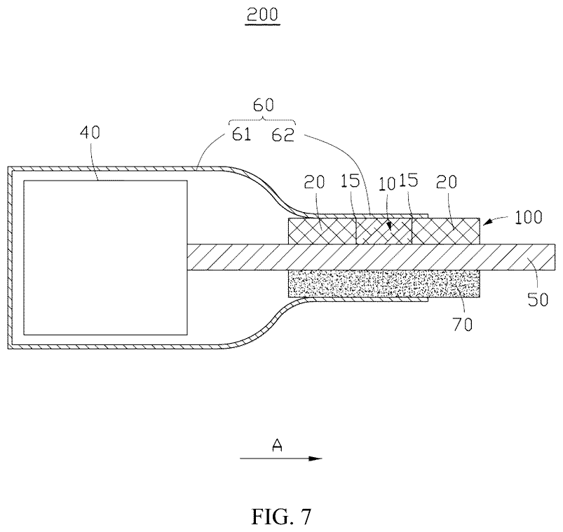

Referring to FIG. 7, an embodiment of this application further provides a battery cell 200, including an electrode assembly 40, a tab 50, and a packaging bag 60. The packaging bag 60 includes an accommodation portion 61 configured to accommodate the electrode assembly 40 and a sealing portion 62 connected to the accommodation portion 61. One end of the tab 50 is connected to the electrode assembly 40, and another end of the tab extends out from the sealing portion 62. The battery cell 200 further includes the adhesive-sealant 100 disclosed in any one of the above embodiments. In a thickness direction of the adhesive-sealant 100, the adhesive-sealant 100 is disposed between at least one surface of the tab 50 and the sealing portion 62. The adhesive-sealant 100 is at least partially disposed in the sealing portion 62.

The adhesive-sealant 100 is configured to improve the performance of sealing and insulation between the tab 50 and the sealing portion 62. When the temperature of the battery cell 200 rises abnormally, the temperature of the tab 50 also rises accordingly. When the temperature reaches the melting point range of the first adhesive layer 10, the first adhesive layer 10 will melt to reduce the sealing strength at the junction between the first adhesive layer 10 and the sealing portion 62, thereby reducing the sealing strength between the adhesive-sealant 100 and the sealing portion 62. This facilitates the gas generated by high temperature to burst the junction between the adhesive-sealant 100 and the sealing portion 62, reduces the heat accumulation and deformation inside the battery cell 200, and improves the safety of the battery cell 200.

In some embodiments, the first direction A is the same as the extension-out direction of the tab 50.

Still referring to FIG. 1 and FIG. 2, in some embodiments, along the width direction of the tab 50, two sides of the adhesive-sealant 100 protrude beyond the two sides of the tab 50 respectively. Specifically, the width W₁ of the tab 50 satisfies: 1.5 mm≤W₁≤6.0 mm; and a width W₂ by which the adhesive-sealant 100 protrudes beyond the tab 50 in the width direction of the tab 50 satisfies: 1.3 mm≤W₂≤2.5 mm.

Along the extension direction of the tab 50, the height H₁ of the second adhesive layer 20 satisfies: 1.0 mm≤H₁≤1.5 mm; the height H₂ of the first adhesive layer 10 satisfies: 1.5 mm≤H₂≤3.0 mm; and the total height H₃ of the adhesive-sealant 100 satisfies: 3.5 mm≤H₃≤6.0 mm.

Along the thickness direction of the tab 50, the thickness T₁ of the adhesive-sealant 100 satisfies: 0.055 mm≤T₁≤0.1 mm; and the thickness T₂ of the tab 50 satisfies: 0.06 mm≤T₂≤0.1 mm.

Still referring to FIG. 7, in some embodiments, a part of the first adhesive layer 10 or a part of the second adhesive layer 20 is disposed outside the sealing portion 62 along the extension-out direction of the tab 50, so that the adhesive-sealant 100 fully fills the clearance between the sealing portion 62 and the tab 50, thereby improving the performance of sealing and insulation between the tab 50 and the sealing portion 62.

In some embodiments, along the thickness direction of the tab 50, a projection of the first adhesive layer 10 on the sealing portion 62 lies within the range of the sealing portion 62, so that the first adhesive layer 10 is in full contact with the sealing portion 62, thereby making it convenient to reduce the sealing strength between the adhesive-sealant 100 and the sealing portion 62 after the first adhesive layer 10 melts.

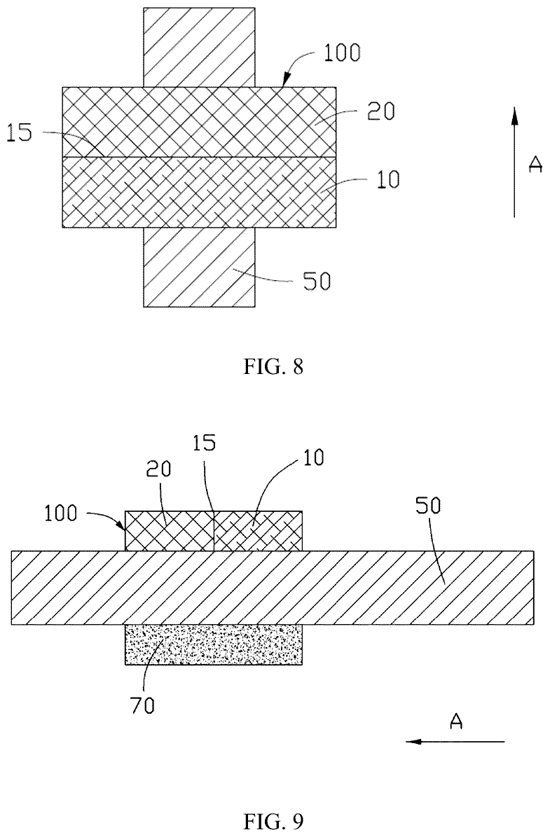

Referring to FIG. 8 and FIG. 9 together, in some embodiments, the number of the first adhesive layers 10 and the number of the second adhesive layers 20 are both one. The first adhesive layer 10 and the second adhesive layer 20 are arranged in sequence along the extension-out direction of the tab 50. Specifically, the first adhesive layer 10 is disposed on one side, close to the electrode assembly 40, of the tab 50, and the second adhesive layer 20 is disposed on one side, away from the electrode assembly 40, of the tab 50. The second adhesive layer 20 is configured to improve the structural strength of the adhesive-sealant 100, and provide support for the first adhesive layer 10 during heat sealing by the adhesive-sealant 100, thereby reducing the risk of adhesive overflow caused by a high deformation rate of the first adhesive layer 10 arising from pressure and high temperature, and in turn, reducing the risk of corrosion of the battery cell 200 and an electrolyte leak at the tab 50 caused by poor sealing. When the temperature of the battery cell 200 rises abnormally and reaches the melting point range of the first adhesive layer 10, the first adhesive layer 10 will melt to reduce the sealing strength on one side, close to the electrode assembly 40, of the sealing portion 62, thereby facilitating the gas generated by high temperature to burst the junction between the adhesive-sealant 100 and the sealing portion 62.

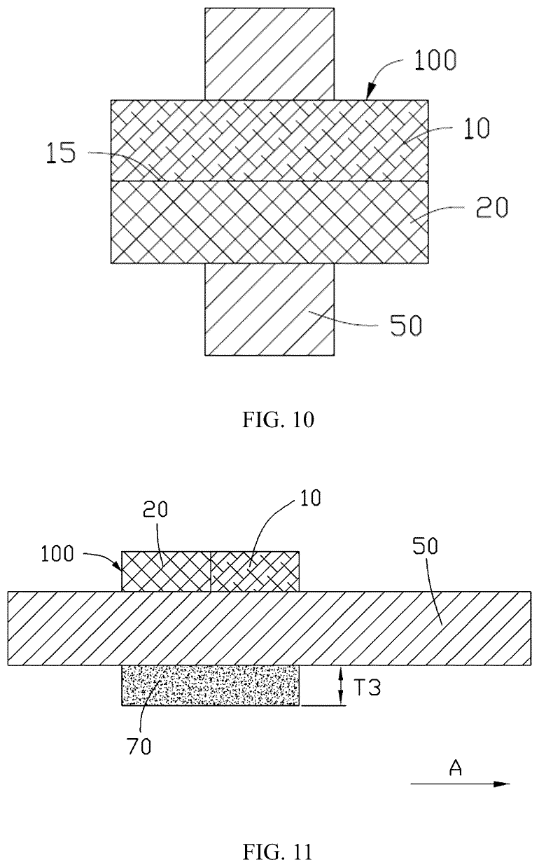

Referring to FIG. 10 and FIG. 11 together, understandably, in some embodiments, the second adhesive layer 20 and the first adhesive layer 10 are arranged sequentially along the extension-out direction of the tab 50. Specifically, the second adhesive layer 20 is disposed on one side, close to the electrode assembly 40, of the tab 50, and the first adhesive layer 10 is disposed on one side, away from the electrode assembly 40, of the tab 50. When the temperature of the battery cell 200 rises abnormally and reaches the melting point range of the first adhesive layer 10, the first adhesive layer 10 will melt to reduce the sealing strength on one side, away from the electrode assembly 40, of the sealing portion 62, thereby facilitating the gas generated by high temperature to burst the junction between the adhesive-sealant 100 and the sealing portion 62.

In some embodiments, the battery cell 200 further includes a third adhesive layer 70 partially disposed in the sealing portion 62. The adhesive-sealant 100 is disposed on one surface of the tab 50. The third adhesive layer 70 is disposed on another surface of the tab 50. The adhesive-sealant 100 and the third adhesive layer 70 are disposed opposite to each other, and are configured to improve the performance of sealing and insulation between each of two surfaces of the tab 50 and the sealing portion 62. In some embodiments, the third adhesive layer 70 includes polypropylene, or may be the adhesive-sealants 100 of any one of the structures described above.

In some embodiments, along the thickness direction of the tab 50, the thickness T₃ of the third adhesive layer 70 satisfies: 0.055 mm≤T₃≤0.1 mm.

Understandably, in some embodiments, the adhesive-sealant 100 is disposed on both surfaces of the battery cell 200. When the temperature of the battery cell 200 rises abnormally and reaches the melting point range of the first adhesive layer 10, the first adhesive layer 10 will melt to reduce the sealing strength of the sealing portions 62 on both sides of the tab 50, thereby facilitating the gas generated by high temperature to burst the junction between the adhesive-sealant 100 on each of the two sides of the tab 50 and the sealing portion 62.

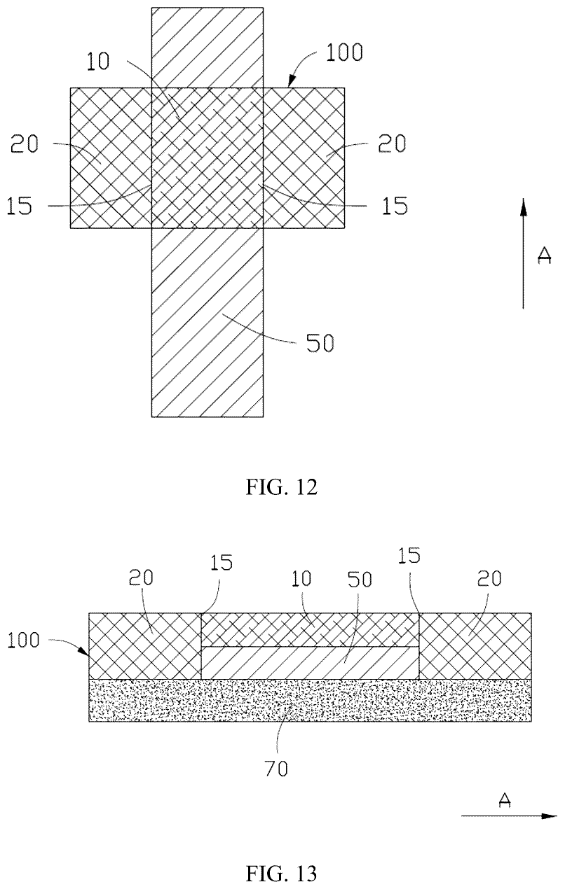

Referring to FIG. 12 and FIG. 13 together, in some embodiments, along the width direction of the tab 50, the two sides of the adhesive-sealant 100 protrude beyond the two sides of the tab 50 respectively. The two sides of the third adhesive layer 70 protrude beyond the two sides of the tab 50 respectively. The protruding parts of the adhesive-sealant 100 and the third adhesive layer 70 on the same side in the width direction of the tab 50 are connected to each other. In this way, the adhesive-sealant 100 and the third adhesive layer 70 wrap around the tab 50 peripherally, and are configured to improve the performance of sealing and insulation between the tab 50 and the sealing portion 62.

In some embodiments, the first direction A is perpendicular to the extension-out direction of the tab 50. The first adhesive layer 10 is disposed between the tab 50 and the sealing portion 62 to penetrate the sealing portion 62 along the extension-out direction of the tab 50. The second adhesive layers 20 are disposed on two sides of the first adhesive layer 10 respectively along the width direction of the tab 50, and protrude beyond the tab 50. The protruding parts of each second adhesive layer 20 and the third adhesive layer 70 on the same side in the width direction of the tab 50 are connected to each other. In this way, the adhesive-sealant 100 and the third adhesive layer 70 wrap around the tab 50 peripherally, and are configured to improve the performance of sealing and insulation between the tab 50 and the sealing portion 62.

Understandably, in some embodiments, when the adhesive-sealant 100 is disposed on both surfaces of the battery cell 200, the protruding parts of the two adhesive-sealants 100 on the same side in the width direction of the tab 50 are connected to each other.

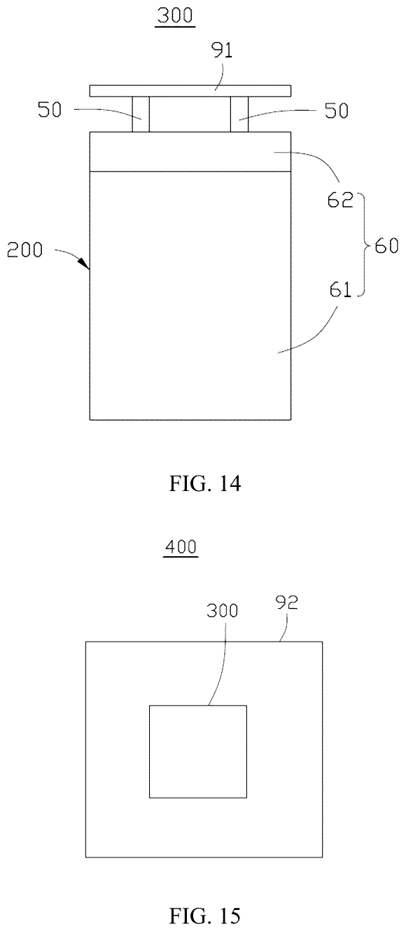

Referring to FIG. 14, an embodiment of this application further provides a battery 300. The battery includes the battery cell 200 disclosed in any one of the above embodiments and a protection circuit module 91 connected to the battery cell 200.

Referring to FIG. 15, an embodiment of this application further provides an electric device 400, including the battery 300 disclosed in the above embodiment. The electrical device 400 further includes a device body 92. The battery 300 is electrically connected to the device body 92 to supply power to the device body 92.

In the adhesive-sealant 100, the battery cell 200 containing the adhesive-sealant 100, the battery 300, and the electrical device 400 disclosed herein, the adhesive-sealant 100 is configured to implement connection between the tab 50 and the packaging bag 60 to improve the performance of sealing and insulation at the junction between the tab 50 and the packaging bag 60. When the adhesive-sealant 100 is used in the battery cell 200 and when the temperature of the battery cell 200 rises abnormally, the temperature of the tab 50 also rises accordingly. When the temperature of the battery cell reaches the melting point range of the first adhesive layer 10, the first adhesive layer 10 will melt to reduce the sealing strength at the junction between the first adhesive layer 10 and the packaging bag, thereby reducing the sealing strength between the adhesive-sealant 100 and the packaging bag 60. This facilitates the gas generated by high temperature to burst the junction between the adhesive-sealant 100 and the packaging bag 60, reduces the heat accumulation and deformation inside the battery cell 200, and improves the safety of the battery cell 200.

In addition, a person skilled in the art may make other variations to this application without departing from the essence of this application. The variations made based on the essence of this application still fall within the protection scope of this application.

What is claimed is:

1. An adhesive-sealant, wherein the adhesive-sealant comprises a first adhesive layer and a second adhesive layer arranged continuously along a first direction, the first direction is perpendicular to a thickness direction of the first adhesive layer, a melting point of the first adhesive layer is lower than a melting point of the second adhesive layer, and a difference in the melting point of the first adhesive layer and the melting point of the second adhesive layer is 15° C. to 55° C.

2. The adhesive-sealant according to claim 1, wherein the melting point of the first adhesive layer ranges from 110° C. to 130° C.

3. The adhesive-sealant according to claim 1, wherein the first adhesive layer comprises one or more of polypropylene or polyethylene; and, when the first adhesive layer comprises the polypropylene and the polyethylene, a mass percent of the polypropylene in the first adhesive layer is 30% to 50%, and a mass percent of the polyethylene in the first adhesive layer is 50% to 70%.

4. The adhesive-sealant according to claim 1, wherein the second adhesive layer comprises fibers and polypropylene, a mass percent of the fibers in the second adhesive layer is 3% to 10%, and a mass percent of the polypropylene in the second adhesive layer is 90% to 97%.

5. The adhesive-sealant according to claim 1, wherein the adhesive-sealant comprises two second adhesive layers, and, along the first direction, the first adhesive layer is disposed between the two second adhesive layers.

6. The adhesive-sealant according to claim 1, wherein the adhesive-sealant further comprises a plurality of through-holes created on the second adhesive layer, and each of the through-holes penetrates the second adhesive layer along a thickness direction of the second adhesive layer.

7. The adhesive-sealant according to claim 6, wherein a distance from a center of the plurality of through-holes to a junction between the first adhesive layer and the second adhesive layer is less than or equal to 0.8 mm.

8. A battery cell, comprising an electrode assembly, a tab, and a packaging bag; wherein the packaging bag comprises an accommodation portion configured to accommodate the electrode assembly and a sealing portion connected to the accommodation portion; one end of the tab is connected to the electrode assembly, and another end of the tab extends out from the sealing portion; wherein, the battery cell further comprises an adhesive-sealant, wherein the adhesive-sealant comprises a first adhesive layer and a second adhesive layer arranged continuously along a first direction, the first direction is perpendicular to a thickness direction of the first adhesive layer, a melting point of the first adhesive layer is lower than a melting point of the second adhesive layer, and a difference in the melting point of the first adhesive layer and the melting point of the second adhesive layer is 15° C. to 55° C.; and
in a thickness direction of the adhesive-sealant, the adhesive-sealant is disposed between at least one surface of the tab and the sealing portion, and the adhesive-sealant is at least partially disposed in the sealing portion.

9. The battery cell according to claim 8, wherein a part of the first adhesive layer or a part of the second adhesive layer is disposed outside the sealing portion along a direction of the tab extending out from the sealing portion.

10. The battery cell according to claim 8, wherein the battery cell further comprises a third adhesive layer partially disposed in the sealing portion, the adhesive-sealant is disposed on one surface of the tab, and the third adhesive layer is disposed on another surface of the tab, and the adhesive-sealant and the third adhesive layer are disposed opposite to each other.

11. The battery cell according to claim 8, wherein the melting point of the first adhesive layer ranges from 110° C. to 130° C.

12. The battery cell according to claim 8, wherein the first adhesive layer comprises one or more of polypropylene and polyethylene; and, when the first adhesive layer comprises the polypropylene and the polyethylene, a mass percent of the polypropylene in the first adhesive layer is 30% to 50%, and a mass percent of the polyethylene in the first adhesive layer is 50% to 70%.

13. The battery cell according to claim 8, wherein the second adhesive layer comprises fibers and polypropylene, a mass percent of the fibers in the second adhesive layer is 3% to 10%, and a mass percent of the polypropylene in the second adhesive layer is 90% to 97%.

14. The battery cell according to claim 8, wherein the adhesive-sealant comprises two second adhesive layers; and, along the first direction, the first adhesive layer is disposed between the two second adhesive layers.

15. The battery cell according to claim 1, wherein the adhesive-sealant further comprises a plurality of through-holes created on the second adhesive layer, and each of the through-holes penetrates the second adhesive layer along a thickness direction of the second adhesive layer.

16. The battery cell according to claim 15, wherein a distance from a center of the plurality of through-holes to a junction between the first adhesive layer and the second adhesive layer is less than or equal to 0.8 mm.

17. An electrical device, wherein the electrical device comprises a battery, the battery comprises a battery cell and a protection circuit module connected to the battery cell; and
the battery cell, comprising an electrode assembly, a tab, and a packaging bag; wherein the packaging bag comprises an accommodation portion configured to accommodate the electrode assembly and a sealing portion connected to the accommodation portion; one end of the tab is connected to the electrode assembly, and another end of the tab extends out from the sealing portion; wherein, the battery cell further comprises an adhesive-sealant; the adhesive-sealant comprises a first adhesive layer and a second adhesive layer arranged continuously along a first direction, the first direction is perpendicular to a thickness direction of the first adhesive layer, a melting point of the first adhesive layer is lower than a melting point of the second adhesive layer, and a difference in the melting point of the first adhesive layer and the melting point of the second adhesive layer is 15° C. to 55° C.; and,
in a thickness direction of the adhesive-sealant, the adhesive-sealant is disposed between at least one surface of the tab and the sealing portion, and the adhesive-sealant is at least partially disposed in the sealing portion.

18. The electrical device according to claim 17, wherein a part of the first adhesive layer or a part of the second adhesive layer is disposed outside the sealing portion along an extension-out direction of the tab.

19. The electrical device according to claim 17, wherein the battery cell further comprises a third adhesive layer partially disposed in the sealing portion, the adhesive-sealant is disposed on one surface of the tab, and the third adhesive layer is disposed on another surface of the tab, and the adhesive-sealant and the third adhesive layer are disposed opposite to each other.

20. The electrical device according to claim 17, wherein the melting point of the first adhesive layer ranges from 110° C. to 130° C.
